(19) United States
(12) Patent Application Publication
(10) Pub. No.: US 2026/0119972 A1
(43) Pub. Date: Apr. 30, 2026

(54) CLUSTERING-BASED PIPELINE FOR DATA SAMPLING

(71) Applicant: Palo Alto Networks, Inc., Santa Clara, CA (US)

(72) Inventors: Dongdong Sun, Sunnyvale, CA (US); Anirudh Mittal, Fremont, CA (US); Ashwin Kumar Kannan, San Francisco, CA (US); Sihang Song, Santa Clara, CA (US)

(21) Appl. No.: 18/932,567

(22) Filed: Oct. 30, 2024

(51) Int. Cl. G06N 20/00

(52) U.S. Cl. CPC G06N 20/00

(57) ABSTRACT

A clustering-based pipeline is trained with training data to generate clusters of the labeled training data and yield a trained clustering model. Previously unseen data or unlabeled data is input into the trained clustering-based pipeline for the trained clustering model to determine cluster memberships of the unseen/unlabeled data. The trained clustering-based pipeline then selects from the unlabeled data for labeling based on cluster membership, including based on non-cluster membership or being out-of-distribution (OOD) with respect to the clusters. The trained clustering-based pipeline samples at different sampling sizes depending on whether embeddings are cluster members or OOD. The sampling will favor the OOD embeddings to provide more of the unlabeled data that corresponds to the OOD embeddings for labeling in order to improve or enrich training data.

### BACKGROUND

The disclosure generally relates to a machine learning based pipeline that informs data sampling (e.g., CPC subclass G06F).

Pre-processing for machine learning includes multiple operations, one of which is annotating and or labeling training data in the case of supervised or semi-supervised learning. Data annotation generally refers to annotating data and includes data labeling. Annotating data adds information (e.g., semantic information or metadata) to raw data that can be considered or processed later. Data labeling refers more specifically to adding a piece of information (i.e., label) to provide context and/or a target (e.g., classification) to a model when training. Quality training data facilitates accuracy in output by trained models. Obtaining quality training data requires a substantial amount of manual labeling guided by domain knowledge.

### BRIEF DESCRIPTION OF THE DRAWINGS

Embodiments of the disclosure may be better understood by referencing the accompanying drawings.

FIG. 1 is a diagram of a clustering-based pipeline being trained on training data and clustering the training data.

FIG. 2 is a diagram of the trained clustering-based pipeline sampling unlabeled data for labeling based on cluster memberships and being out-of-distribution.

FIG. 3 depicts an enlarged view of the overlay 211 to illustrate cluster memberships that will determine samplings.

FIG. 4 is a flowchart of example operations for training a clustering-based pipeline for unseen data sampling.

FIG. 5 is a flowchart of example operations for sampling unlabeled data for labeling based on cluster memberships.

FIG. 6 is a flowchart of example operations for identifying a cluster characteristic corresponding to greater sampling size and sampling unlabeled data accordingly.

FIG. 7 depicts an example computer system with a clustering-based sampling pipeline.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The term “pipeline” is used herein to refer to multiple software components logically arranged in series for output of a software component to be input for a next software component. The pipeline likely includes program code to logically connect the software components to allow flow of inputs and outputs without manual intervention.

The description describes clustering of embeddings of data. The data itself is not being clustered. The embeddings of the data are being clustered. However, to be succinct, some of the description in the context of clusters and cluster membership will refer to the data instead of the embeddings that represent the data. For instance, the description may refer to unlabeled data being a member of a cluster when the embedding representing the unlabeled data is the cluster member.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

A clustering-based pipeline has been developed to intelligently sample unseen or unlabeled data to create more comprehensive training data that can be used to increase accuracy of machine learning models and avoid or limit bias. The clustering-based pipeline is primed/trained with training data to generate clusters of the labeled training data and yield a trained clustering model. As clustering is unsupervised, the training data may or may not be labeled. However, the training data has a known attribute (e.g., sensitive data) that will be used to train a model (e.g., a classifier), whether explicitly indicated as a label or annotation or implicitly indicated due to curation or selection. Previously unseen data or unlabeled data is input into the trained clustering-based pipeline for the trained clustering model to determine cluster memberships of the unseen/unlabeled data (hereinafter “unlabeled data”). The trained clustering-based pipeline then selects from the unlabeled data for labeling based on cluster membership, including based on non-cluster membership or being out-of-distribution (OOD) with respect to the clusters. The trained clustering-based pipeline samples at different sampling sizes depending on whether embeddings are cluster members or OOD. The sampling will favor the OOD embeddings to provide more of the unlabeled data that corresponds to the OOD embeddings for labeling in order to improve or enrich training data.

### Example Illustrations

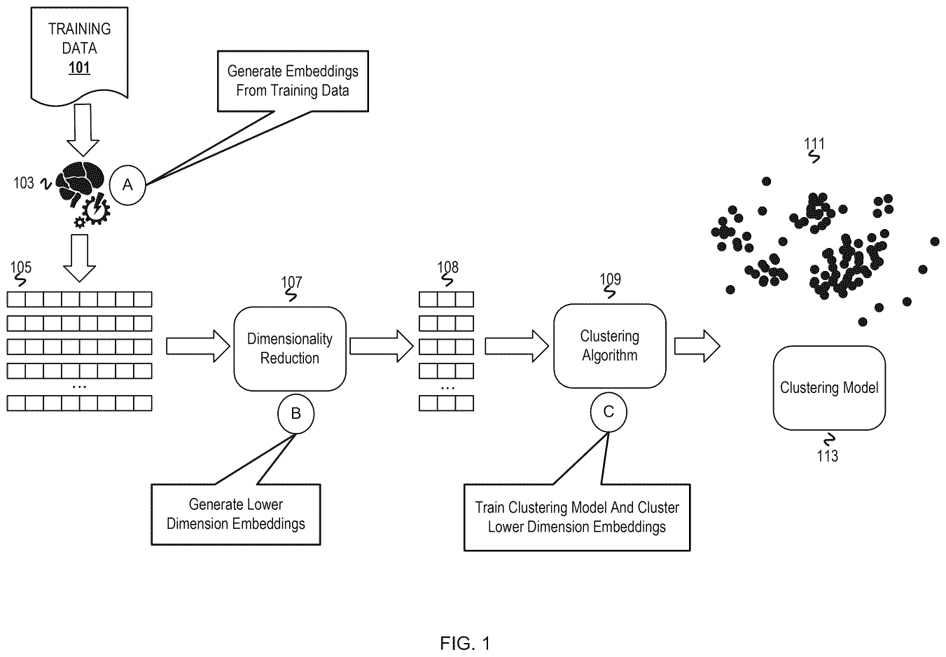

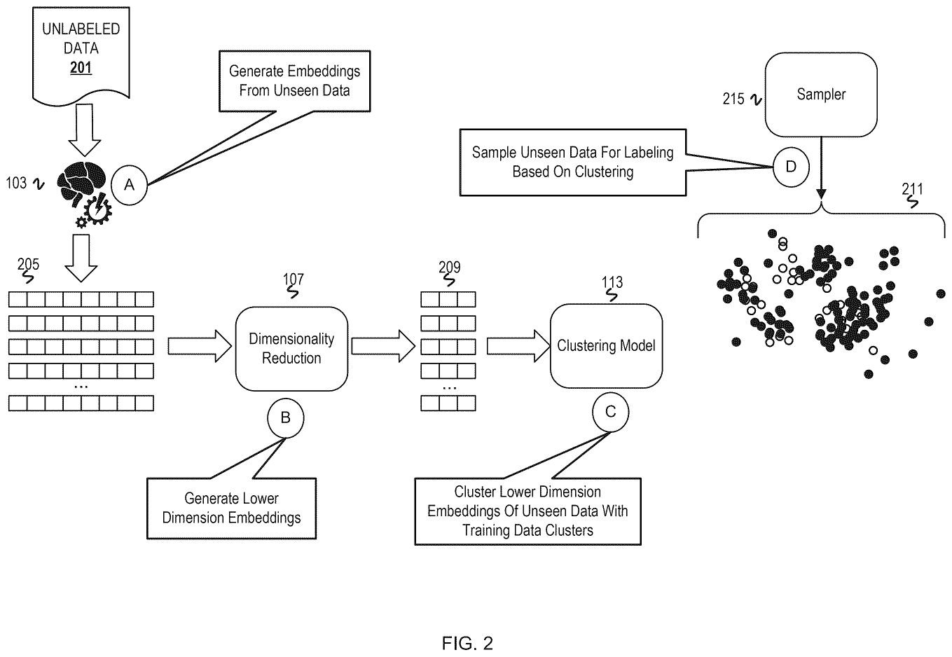

FIGS. 1 and 2 are diagrams depicting training of a clustering-based pipeline and use of the trained clustering-based pipeline to efficiently and intelligently sample previously unlabeled data for labeling. FIG. 1 is a diagram of a clustering-based pipeline being trained on training data and clustering the training data. The clustering-based pipeline to be trained includes an embedding model 103 (e.g., deep neural network), a dimensionality reduction component 107 (e.g., a uniform manifold approximation and projection (UMAP) tool, principal component analysis (PCA) implementation, t-SNE (t-stochastic distributed neighbor embedding), or SONG (Self-Organizing Nebulous Growths)), and a clustering algorithm component 109 (an implementation of a hierarchical and/or density-based clustering algorithm).

FIG. 1 is annotated with a series of letters A-C that each represent a stage of one or more operations. Although these stages are ordered for this example, the stages illustrate one example to aid in understanding this disclosure and should not be used to limit the claims. Subject matter falling within the scope of the claims can vary from what is illustrated.

At stage A, the embedding model 103 generates vector embeddings or embeddings 105 from training data 101. The embedding model 103 learns an embedding space based on the training data. If the training data 101 are United States (US) passport data, then the embedding model 103 will learn an embedding space for US passport data. If the training data 101 are bank account data, then the embedding model 103 will learn an embedding space for bank account data.

At stage B, the dimensionality reduction component 107 generates reduced dimension or lower dimension embeddings 108. The dimensionality reduction component 107 learns a latent space or latent feature space and produces a trained dimensionality reduction mode. This transforms the higher dimension embeddings 105 into the lower dimension embeddings 108.

At stage C, the clustering algorithm component 109 trains a clustering model to learn a cluster space of the lower dimension embeddings 108. This results in clustering (or clusters) 111 and a trained clustering model 113.

FIG. 2 is a diagram of the trained clustering-based pipeline sampling unlabeled data for labeling based on cluster memberships and being OOD. FIG. 2 depicts a sampler 215 that can be added to the clustering-based pipeline when deployed or process the cluster memberships output by the clustering-based pipeline.

FIG. 2 is annotated with a series of letters A-D that each represent a stage of one or more operations. Although these stages are ordered for this example, the stages illustrate one example to aid in understanding this disclosure and should not be used to limit the claims. Subject matter falling within the scope of the claims can vary from what is illustrated.

At stage A, the embedding model 103 generates embeddings 205 from unlabeled data 201. The embeddings 205 are generated based on the embedding space learned for training data 101.

At stage B, the dimensionality reduction component 107 generates lower dimension embeddings 209. The dimensionality reduction component 107 transforms the higher dimension embeddings 205 into the lower dimension embeddings 209 based on projecting or mapping the embeddings 205 to the latent space learned from the training data 101.

At stage C, the clustering model 113 determines memberships of the lower dimension embeddings 209 with respect to the clustering 111. In FIG. 2, a composite 211 illustrates empty circles that represent the lower dimension embeddings 209 with the clustering 111 which is depicted with filled circles representing the lower dimension embeddings 108.

At stage D, the sampler 215 samples the unlabeled data 201 based on cluster memberships of the lower dimension embeddings 209. The sampler 215 samples from the unlabeled data 201 based on cluster memberships of the corresponding ones of the embeddings 209. The sampler 215 samples at a larger sample size from those of the unlabeled data 201 with corresponding ones of the embeddings 209 that are OOD. After sampling, the sampler 215 indicates the samples for labeling.

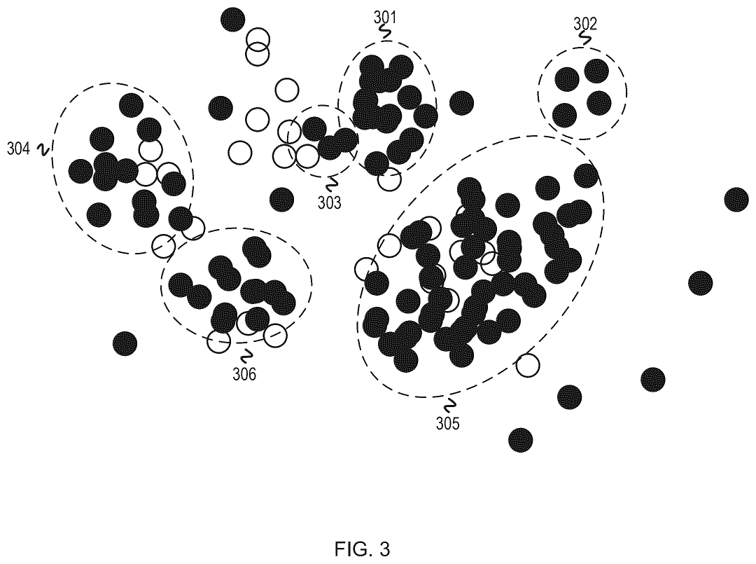

FIG. 3 depicts an enlarged view of the composite 211 to illustrate cluster memberships that will determine samplings. The enlarged view of the composite 211 has been annotated with dashed ovals 301-305 in FIG. 3 to indicate clusters. Implementations can define different sample sizes for OOD data and unlabeled data that are members of clusters, and implementations can further define multiple sample sizes for clusters with different characteristics. The unlabeled data represented by the unfilled circles that are not members of any of the clusters 301-305 (outliers) will be sampled with a largest sample size based on an assumption that more labeling resources should be allocated to OOD data. While not necessary, this illustration presumes that well-represented clusters (i.e., those in which trained data is substantially represented according to defined thresholds and unlabeled data has low membership) will be sampled at a smaller sample size than clusters that are not well-represented. Assuming sample size is indicated as a percentage and sample sizes of 90%, 70% (not well-represented), and 10% (well-represented) are defined, the outliers will be sampled at 90%, for example, because the largest sample size will be allocated to outliers or unlabeled data that does not have membership in any of the clusters 301-305. For the clusters 301 and 304-306, the 10% sample size will be used since the clusters 301 and 304-306 (presumably) satisfy a defined minimum membership of training data and threshold ratio of training data to unlabeled data for a “well-represented” cluster. None of the unlabeled data is assigned membership to the cluster 302. For this illustration, it is assumed that the cluster 303 does not satisfy the criteria of a “well-represented” cluster. Thus, the unlabeled data with low dimension embeddings in this cluster 303 will be sampled at 70%.

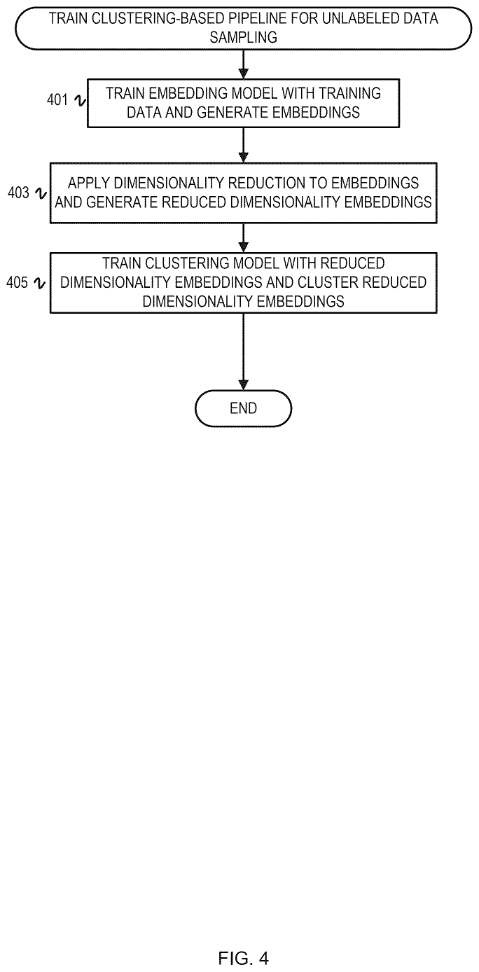

FIG. 4 is a flowchart of examples operations for training a clustering-based pipeline for unlabeled data sampling. While this technique of using the clustering-based pipeline can be used for a variety of training data, it is likely that the resulting trained clustering-based pipeline cannot be used as if agnostic of the attribute of the training data that will be used for training another model. For instance, a clustering-based pipeline trained with training data of benign and malicious e-mails would be used to sample unlabeled e-mail data for labeling and to then train a malicious e-mail classifier with the labeled data. As another example, a clustering-based pipeline trained with training data of driver's license data across states of the US would be used to sample unlabeled US driver license data for labeling to then train a sensitive data classifier or data leakage detector. FIG. 4 is described with reference to a pipeline trainer which logically represents the trainers of the individual models. More concretely, the “trainer” is a set of function calls defined by a library for each different model type to train the model.

At block 401, a trainer trains an embedding model with training data and generates embeddings from the training data. Examples of models that can be trained to generate the embeddings include an autoencoder, ELMo (Embeddings from Language Models), GPT (Generative Pre-trained Transformer), BERT (Bidirectional Encoder Representations from Transformers), and GloVe (Global Vectors for Word Representation).

At block 403, the trainer applies dimensionality reduction to the embeddings and generates reduced dimensionality embeddings. While generating embeddings from training data already reduces dimensionality of the training data, the additional dimensionality reduction further reduces the embeddings as pre-processing for clustering. As previously mentioned, a UMAP or PCA tool can be used for this dimensionality reduction. Implementations can use other approaches for dimensionality reduction, such as an autoencoder.

At block 405, the trainer trains a clustering model with the reduced dimensionality embeddings and clusters the reduced dimensionality embeddings. Examples of clustering algorithms that can be used to train a clustering model include DBSCAN (Density-Based Spatial Clustering of Applications with Noise), HDBSCAN (Hierarchical DBSCAN), Gaussian Mixture Models, and k-means clustering. Hyperparameter optimization is used to determine optimal hyperparameters, such as minimum cluster size, number of clusters, minimum data to form a dense region, and neighborhood radius. For example, Bayesian hyperparameter optimization search can be used with an objective function defined by silhouette scoring.

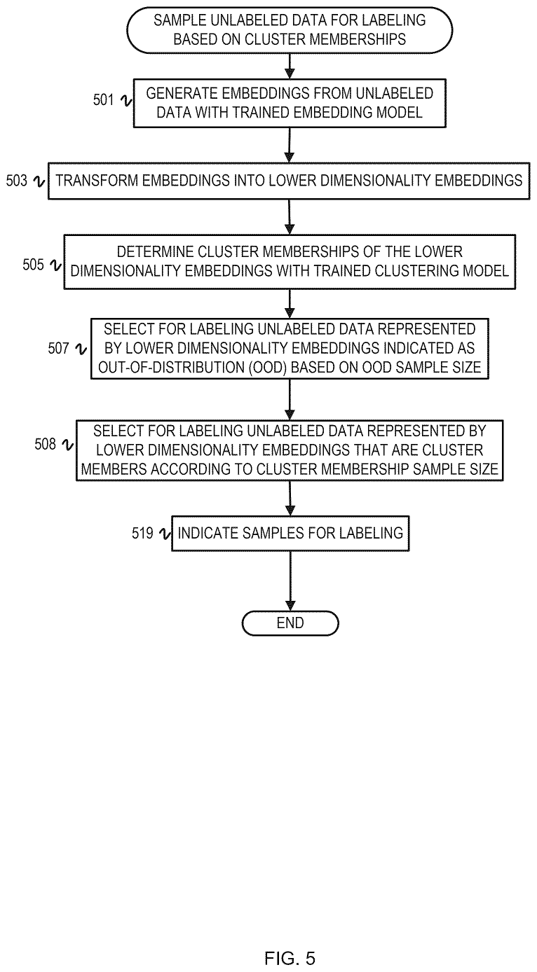

FIG. 5 is a flowchart of example operations for sampling unlabeled data for labeling based on cluster memberships. Whether data are referred to as previously unseen or unlabeled, the attribute of interest of the training data is unknown for the unseen/unlabeled data. The example operations of FIG. 5 are described with reference to a clustering-based pipeline for consistency with the earlier Figures and/or ease of understanding. The name chosen for the program code (e.g., trainer, clustering-based pipeline, etc.) is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

At block 501, the clustering-based pipeline generates embeddings from unlabeled data with a trained embedding model. For example, the clustering-based pipeline iteratively invokes the trained embedding model for each entry/datum of the unlabeled data. The unlabeled data may be selected from a larger dataset and/or accumulated from a production environment. For instance, numerous alerts for possibly sensitive data detected by a data leakage prevention system on a daily basis can be accumulated and input into the pipeline for sampling so that an intelligently selected subset can be labeled.

At block 503, the clustering-based pipeline transforms the embeddings into lower dimension embeddings with the trained dimensionality reduction model. For instance, the clustering-based pipeline invokes a UMAP tool to project each of the embeddings into the latent space learned from the training data.

At block 505, the clustering-based pipeline determines cluster memberships of the lower dimensionality embeddings with the trained clustering model of the pipeline. The clustering-based pipeline, for each lower dimension embedding, calls a function of the trained clustering model that determines cluster membership with respect to the training data clusters. If the clustering model returns an indication of outlier or noise, the clustering-based pipeline indicates that the lower dimension embedding is OOD.

At block 507, the clustering-based pipeline selects for labeling unlabeled data represented by lower dimensionality embeddings indicated as OOD. The selection is according to a defined OOD sample size. The OOD sample size can be expressed differently depending on implementation. For instance, the OOD sample size may be 100% of OOD data. The sample size may be a percentage of the OOD data or a relative size with respect to sample ceiling. For example, a sample ceiling may be 200 samples and OOD data allocated 50% of the sample ceiling. Regardless of the specific implementation, sampling OOD data at a greater size or proportion enriches the training data and allows for the training data to capture shifts.

At block 508, the clustering-based pipeline selects for labeling unlabeled data represented by lower dimensionality embeddings that are cluster members according to cluster membership sample size. As mentioned previously, the cluster membership sample size will be less than the OOD sample size.

At block 519, the clustering-based pipeline indicates the samples for labeling. For instance, the clustering-based pipeline can store the samples in a repository of data to be labeled. In some cases, the clustering-based pipeline can annotate the samples with information from the corresponding clusters, such as a cluster label, to provide additional information for labeling. Prioritization of labeling OOD data and unlabeled data in low performance clusters can improve accuracy of a model trained with the labeled data and can be used to address semantic drift.

The sampling size for unlabeled data that are cluster memberships can have more intelligence than that depicted in FIG. 5. The clustering-based pipeline can discriminate between well-represented clusters and clusters that are not well-represented. The criteria distinguishing well-represented and not well-represented, can vary (e.g., ratio of training data in a cluster to unlabeled data assigned membership to the cluster, cluster size, cluster density, etc.). In addition, performance of a model trained with labeled data corresponding to clusters can be tracked in correlation with the clusters to identify low performance clusters. A “low performance” cluster can be a cluster that represents a class of data (i.e., data having a common attribute) for which model performance is degrading or fails to satisfy a performance threshold. Furthermore, clusters can be tracked to identify a cluster that is shifting. For these various cluster characteristics, the clustering-based pipeline can use a greater sampling size than a base sample size defined for cluster membership.

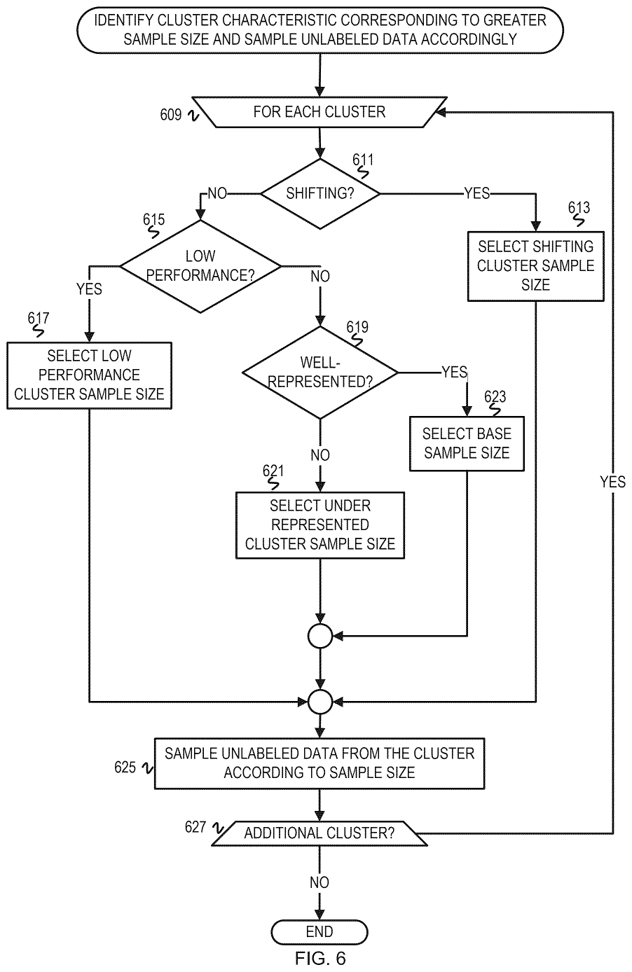

FIG. 6 is a flowchart of example operations for identifying a cluster characteristic corresponding to greater sampling size and sampling unlabeled data accordingly. While FIG. 6 depicts example operations that use a larger sample size(s) for various cluster characteristics, embodiments may address one or multiple of these cases. The example operations of FIG. 6 presume prioritization, from highest to lowest priority, for identifying a shifting cluster, a low performance cluster, and finally a well-represented cluster. Implementations can perform the example operations of FIG. 6 instead of the example operation of block 508 in FIG. 5.

At block 609, the clustering-based pipeline begins to iterate through the clusters of training data. Each cluster will have an identifier assigned to it by the clustering model.

At block 611, the clustering-based pipeline determines whether the cluster is shifting. A shifting cluster represents dataset shift with respect to the data represented by the cluster. The clustering-based pipeline can track location of cluster centers/centroids boundaries or trajectories over time. As another example, an amount or proportion of OOD data points can be tracked over time and a shift indicated if the amount of OOD data points exceeds a defined limit. If a shift is detected, then operational flow proceeds to block 613. Otherwise, operational flow proceeds to block 615.

At block 613, the clustering-based pipeline selects a shifting cluster sample size. A sample size will have been defined for sampling from a cluster detected as shifting to adapt to the shifting of the underlying class of data. A larger sampling of this unlabeled data allows for the labeling resources to be allocated for capturing the changes in characteristics. Operational flow proceeds from block 613 to block 625.

At block 615, the clustering-based pipeline determines whether the cluster is a low performance cluster. As previously mentioned, a low performance cluster is a cluster of embeddings that corresponds to a class of data for which a trained model has low or degrading performance (e.g., decreasing true positive rate and/or increasing false positive rate). If the clustering-based pipeline determines that the cluster is a low performance cluster, then operational flow proceeds to block 617. Otherwise, operational flow proceeds to block 619.

At block 617, the clustering-based pipeline selects a low performance cluster sample size. A sample size will have been defined for sampling from a low performance cluster. Allocating more samples to unlabeled data that are members of a low performance cluster creates more training data for the corresponding class of data that should improve performance of the model. Operational flow proceeds from block 617 to block 625.

At block 619, the clustering-based pipeline determines whether the cluster is well-represented. Examples of the various criteria to determine whether a cluster is well-represented were mentioned earlier. If not detected as a low performance cluster, performance corresponding to the class of data corresponding to a cluster that is not well-represented (or underrepresented) may eventually be low performing. As a proactive measure, a larger allocation of samples can be for a cluster that is underrepresented than well-represented clusters to avoid the possibility of low performance. If the clustering-based pipeline determines that the cluster is not well-represented, then operational flow proceeds to block 621. Otherwise, operational flow proceeds to block 623 for selection of the base sample size (i.e., the sample size defined for membership in a cluster without a characteristic warranting a larger sample size). Operational flow proceeds from block 623 to block 625.

At block 621, the clustering-based pipeline selects an underrepresented cluster sample size. A sample size will have been defined for sampling from an underrepresented cluster. Operational flow proceeds from block 621 to block 625.

At block 625, the clustering-based pipeline samples the unlabeled data from the cluster according to the selected sample size. The clustering-based pipeline determines which low dimensionality embeddings are members of the cluster and samples those embeddings according to the selected sample size. The clustering-based pipeline then determines which of the unlabeled data are represented by the samples. The clustering-based pipeline will have maintained mappings between the unlabeled data and the lower dimensionality embeddings.

At block 627, the clustering-based pipeline determines whether there is another cluster to process. If there is another cluster to process, then operational flow returns to block 609. Otherwise, operational flow proceeds to indicate the sampled data for labeling, such as in block 519 of FIG. 5.

### VARIATIONS

Performance of a model trained with training data yielded from the clustering-based pipeline (i.e., labeled based on sampling by the pipeline) can be tracked in tandem with distributions of unlabeled data with respect to distributions of training data. If model performance declines and unlabeled data distribution suggests semantic shift, retraining can be targeted. OOD data corresponding to the shift can be sampled for labeling and used to train the model to adapt to the semantic shift and thus maintain relevance and effectiveness of the model.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

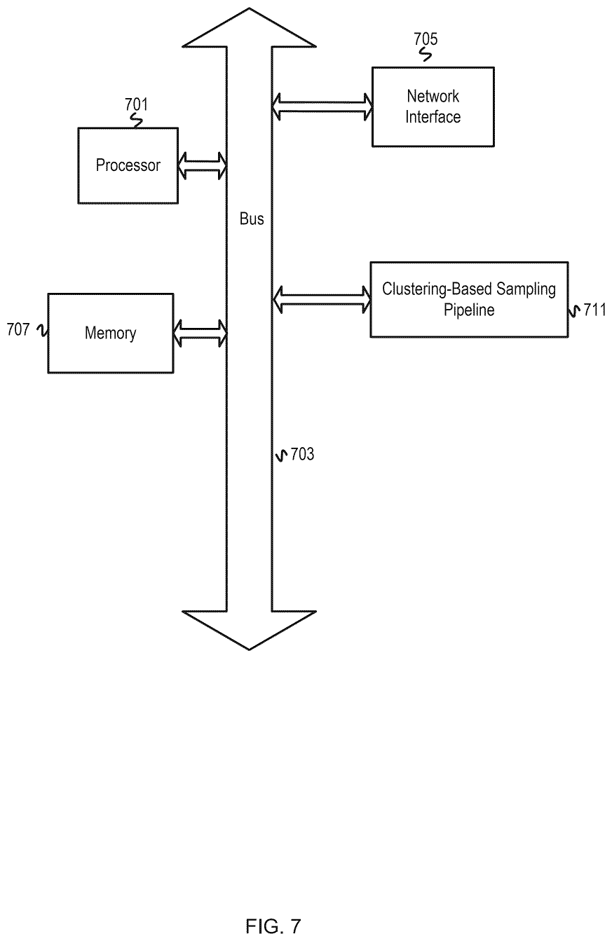

FIG. 7 depicts an example computer system with a clustering-based sampling pipeline. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes clustering-based sampling pipeline 711. The clustering-based sampling pipeline 711 is trained to transform raw input data into low dimensionality vectors or vector embeddings for clustering. Components of the clustering-based sampling pipeline 711 are trained with training data to learn a first embedding space and a lower dimension space of the first embedding space to reduce embeddings for clustering. A clustering component of the clustering-based sampling pipeline 711 is trained to learn a clustering space of the training data. After training, the clustering-based sampling pipeline 711 is run on “live” data (e.g., unseen or unlabeled data) to obtain cluster memberships of low dimension representations of the live data and then to sample from the live data based on membership statistics and non-membership or being OOD. The clustering-based sampling pipeline 711 is used to identify a subset of live data for data annotation or labeling that improves and/or adapts a training dataset to increase the accuracy of a model that will be trained by the training dataset. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
training a clustering model with embeddings of a first set of data, wherein the training generates clusters of the embeddings of the first set of data;
running the clustering model on embeddings of a second set of data;
sampling, according to a first set of one or more sampling sizes, from those of the second set of data that are members of the clusters;
sampling, based on a second sampling size, from those of the second set of data out-of-distribution (OOD) with respect to the clusters; and
indicating the samples of the second set of data for labeling.

2. The method of claim 1, wherein the sampling from those of the second set of data that are members of the clusters comprises sampling, from each cluster, those of the second set of data that are members of the cluster at one of the first set of sample sizes based on performance of the cluster.

3. The method of claim 1 further comprising prioritizing labeling of the samples from the second set of data that are OOD.

4. The method of claim 1 further comprising tracking performance of a model trained with at least the first set of data in correlation with the clustering over time and adjusting sampling based, at least in part, on a trend in the clustering.

5. The method of claim 4, wherein adjusting the sampling comprises biasing sampling of a cluster that is shifting.

6. The method of claim 1 further comprising tracking performance of a model trained with at least the first set of data with respect to each of at least a subset of the clusters and prioritizing sampling from a low performance cluster, wherein a low performance cluster is a cluster representing a class of data for which the model has low or decreasing performance.

7. The method of claim 1 further comprising training a classifier with at least the second set of data after the second set of data has been labeled.

8. A non-transitory, machine-readable medium having program code stored thereon, the program code comprising instructions to:
train a clustering model with embeddings of a first set of data, wherein the training generates clusters of the embeddings of the first set of data;
run the clustering model on embeddings of a second set of data;
sample from the second set of data based, at least in part, on cluster membership and, at a different sample size, from the second set of data based on being out-of-distribution (OOD) with respect to the clusters; and
indicate the samples of the second set of data for labeling.

9. The non-transitory, machine-readable medium of claim 8, wherein the instructions to sample from the second set of data based on cluster membership comprise the instructions to sample from the second set of data based on cluster performance, wherein cluster performance is based on performance of a model with respect to a class of data represented by a cluster.

10. The non-transitory, machine-readable medium of claim 8, wherein the program code further comprises instructions to track over time performance of a model trained with at least the first set of data in correlation with the clustering and to adjust sampling based, at least in part, on a trend in the clustering.

11. The non-transitory, machine-readable medium of claim 10, wherein the instructions to adjust the sampling comprise instructions to bias sampling a cluster that is shifting.

12. The non-transitory, machine-readable medium of claim 8, wherein the program code further comprises instructions to track performance of a model trained with at least the first set of data with respect to each of at least a subset of the clusters and to prioritize sampling for a low performance cluster, wherein a low performance cluster is a cluster representing a class of data for which the model has low or decreasing performance.

13. The non-transitory, machine-readable medium of claim 8 wherein the program code further comprises instructions to prioritize labeling of the samples from the second set of data that are OOD.

14. The non-transitory, machine-readable medium of claim 8, wherein the program code further comprises instructions to train a model to learn an embedding space of the first set of data and generate the embeddings of the first set of data and the embeddings of the second set of data with the trained embedding model.

15. An apparatus comprising:
a processor; and
a machine-readable medium having instructions stored thereon that are executable by the processor to cause the apparatus to,
train a clustering model with embeddings of a first set of data, wherein the training generates clusters of the embeddings of the first set of data;
run the clustering model on embeddings of a second set of data;
sample from the second set of data based, at least in part, on cluster membership and, at a different sample size, from the second set of data based on being out-of-distribution (OOD) with respect to the clusters; and
indicate the samples of the second set of data for labeling.

16. The apparatus of claim 15, wherein the instructions to sample from the second set of data based on cluster membership comprise the instructions being executable by the processor to cause the apparatus to sample from the second set of data based on cluster performance, wherein cluster performance is based on performance of a model with respect to a class of data represented by a cluster.

17. The apparatus of claim 15, wherein the machine-readable medium further has stored thereon instructions executable by the processor to cause the apparatus to track over time performance of a model trained with at least the first set of data in correlation with the clustering and to adjust sampling based, at least in part, on a trend in the clustering.

18. The apparatus of claim 17, wherein the instructions to adjust the sampling comprise the instructions being executable by the processor to cause the apparatus to bias sampling a cluster that is shifting.

19. The apparatus of claim 15, wherein the machine-readable medium further has stored thereon instructions executable by the processor to cause the apparatus to track performance of a model trained with at least the first set of data with respect to each of at least a subset of the clusters and to prioritize sampling for a low performance cluster, wherein a low performance cluster is a cluster representing a class of data for which the model has low or decreasing performance.

20. The apparatus of claim 15, wherein the machine-readable medium further has stored thereon instructions executable by the processor to cause the apparatus to train a model to learn an embedding space of the first set of data and generate the embeddings of the first set of data and the embeddings of the second set of data with the trained embedding model.
